(19) United States
(12) Patent Application Publication
(10) Pub. No.: US 2022/0361213 A1
(43) Pub. Date: Nov. 10, 2022

(54) INDICATION OF UNAVAILABLE RESOURCES

(71) Applicant: QUALCOMM Incorporated, San Diego, CA (US)

(72) Inventors: Seyedkianoush HOSSEINI, San Diego, CA (US); Gabi SARKIS, San Diego, CA (US); Tien Viet NGUYEN, Bridgewater, NJ (US)

(21) Appl. No.: 17/662,196

(22) Filed: May 5, 2022

Related U.S. Application Data
(60) Provisional application No. 63/201,675, filed on May 7, 2021.

(51) Int. Cl. H04W 72/12; H04L 5/00

(52) U.S. Cl. CPC H04W 72/1278; H04W 72/1263; H04L 5/001; H04L 5/0098; H04W 72/1242

(57) ABSTRACT

Various aspects of the present disclosure generally relate to wireless communication. In some aspects, a user equipment (UE) may transmit a coordination indication identifying a set of availability statuses for a set of resources, wherein the coordination indication is an explicit indication or an implicit indication. The UE may communicate on a sidelink or an uplink in accordance with the set of availability statuses. Numerous other aspects are described.

### CROSS-REFERENCE TO RELATED APPLICATION

This Patent Application claims priority to U.S. Provisional Patent Application No. 63/201,675, filed on May 7, 2021, entitled “INDICATION OF UNAVAILABLE RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for indication of unavailable resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LIE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory, and one or more processors, coupled to the memory, configured to: transmit a coordination indication identifying a set of availability statuses for a set of resources, wherein the coordination indication is an explicit indication or an implicit indication; and communicate on a sidelink or an uplink in accordance with the set of availability statuses.

In some aspects, a UE for wireless communication includes a memory, and one or more processors, coupled to the memory, configured to: receive a coordination indication identifying a set of availability statuses for a set of resources, wherein the coordination indication is an explicit indication or an implicit indication; and transmit on a sidelink in a resource selected in accordance with the set of availability statuses.

In some aspects, a method of wireless communication performed by a UE includes transmitting a coordination indication identifying a set of availability statuses for a set of resources, wherein the coordination indication is an explicit indication or an implicit indication; and communicating on a sidelink or an uplink in accordance with the set of availability statuses.

In some aspects, a method of wireless communication performed by a UE includes receiving a coordination indication identifying a set of availability statuses for a set of resources, wherein the coordination indication is an explicit indication or an implicit indication; and transmitting on a sidelink in a resource selected in accordance with the set of availability statuses.

In some aspects, a non-transitory computer-readable medium storing a set of instructions for wireless communication includes one or more instructions that, when executed by one or more processors of a UE cause the UE to: transmit a coordination indication identifying a set of availability statuses for a set of resources, wherein the coordination indication is an explicit indication or an implicit indication; and communicate on a sidelink or an uplink in accordance with the set of availability statuses.

In some aspects, a non-transitory computer-readable medium storing a set of instructions for wireless communication includes one or more instructions that, when executed by one or more processors of a UE, cause the UE to: receive a coordination indication identifying a set of availability statuses for a set of resources, wherein the coordination indication is an explicit indication or an implicit indication; and transmit on a sidelink in a resource selected in accordance with the set of availability statuses.

In some aspects, an apparatus for wireless communication includes means for transmitting a coordination indication identifying a set of availability statuses for a set of resources, wherein the coordination indication is an explicit indication or an implicit indication; and means for communicating on a sidelink or an uplink in accordance with the set of availability statuses.

In some aspects, an apparatus for wireless communication includes means for receiving a coordination indication identifying a set of availability statuses for a set of resources, wherein the coordination indication is an explicit indication or an implicit indication; and means for transmitting on a sidelink in a resource selected in accordance with the set of availability statuses.

Aspects generally include a method, apparatus, system, computer program product, non-transitory computer-readable medium, user equipment, base station, network node, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of coordination signaling, in accordance with the present disclosure.

FIG. 6 is a diagram illustrating an example of sidelink resource reservation, in accordance with the present disclosure.

FIG. 7 is a diagram illustrating an example associated with indication of unavailable resources, in accordance with the present disclosure.

FIGS. 8-9 are diagrams illustrating example processes associated with indication of unavailable resources, in accordance with the present disclosure.

FIG. 10 is a block diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

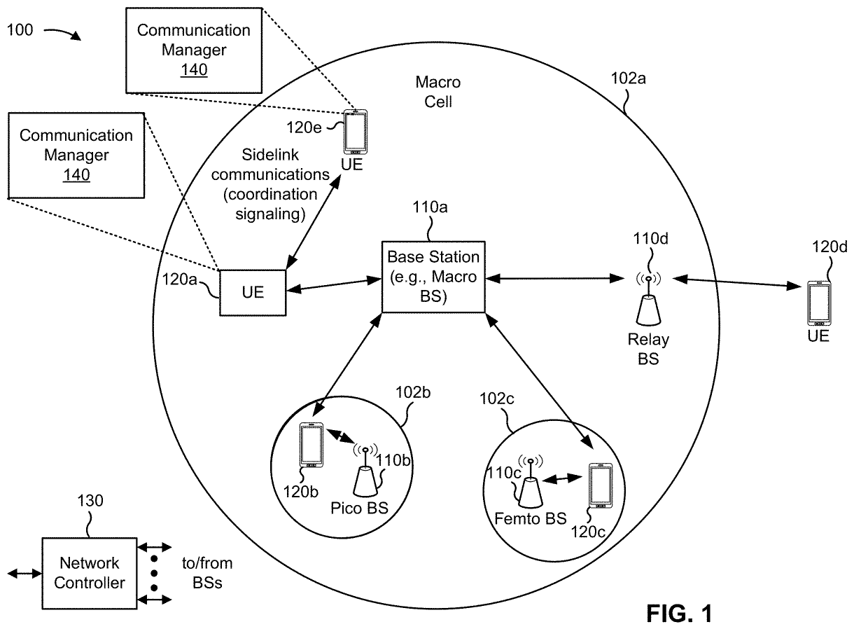

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), TRP, or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more central units (CUs), one or more distributed units (DUs), one or more radio units (RUs), or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

In some aspects, the UE 120 may include a communication manager 140. As described in more detail elsewhere herein, the communication manager 140 may transmit a coordination indication identifying a set of availability statuses for a set of resources, wherein the coordination indication is an explicit indication or an implicit indication; and communicate on a sidelink or an uplink in accordance with the set of availability statuses. The communication manager 140 may receive a coordination indication identifying a set of availability statuses for a set of resources, wherein the coordination indication is an explicit indication or an implicit indication; and transmit on a sidelink in a resource selected in accordance with the set of availability statuses. Additionally, or alternatively, the communication manager 140 may perform one or more other operations described herein.

As indicated above, FIG. 1 is provided as an example. Other examples may differ from what is described with regard to FIG. 1.

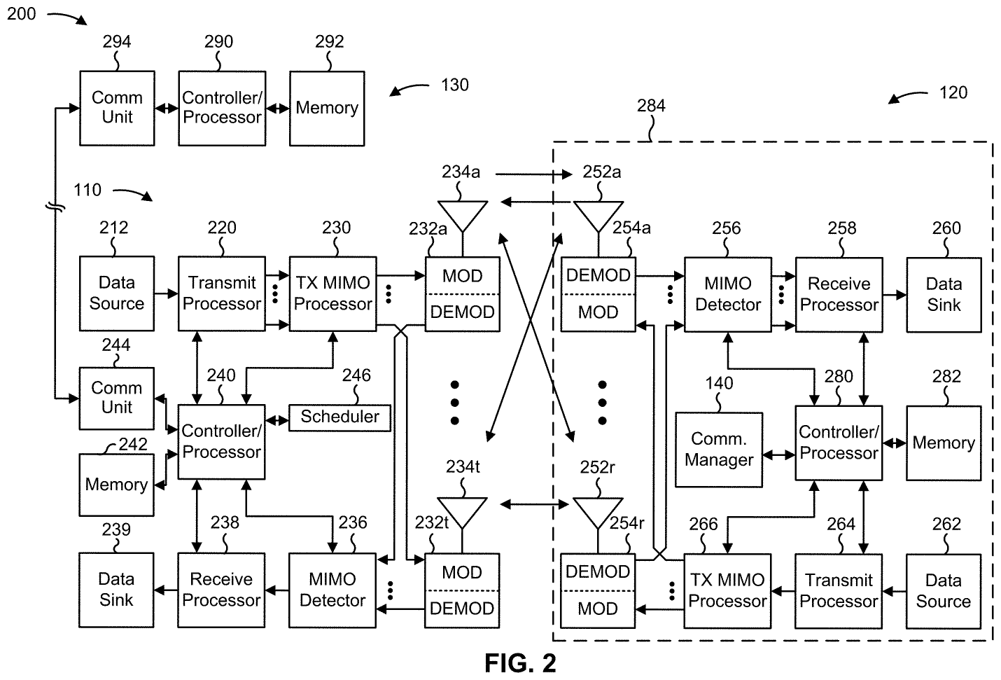

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

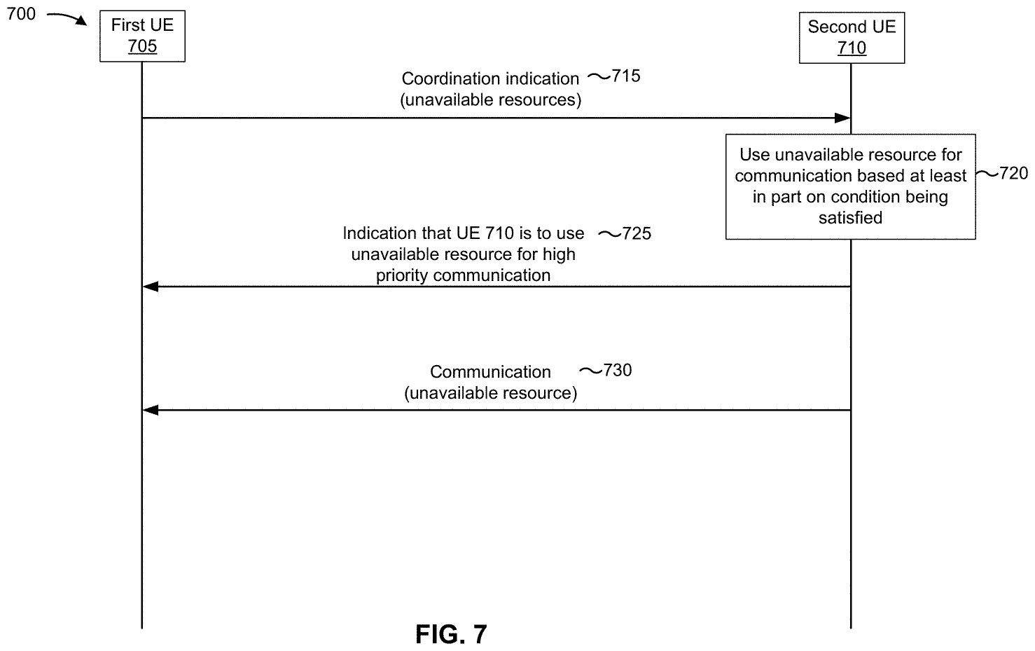

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-10).

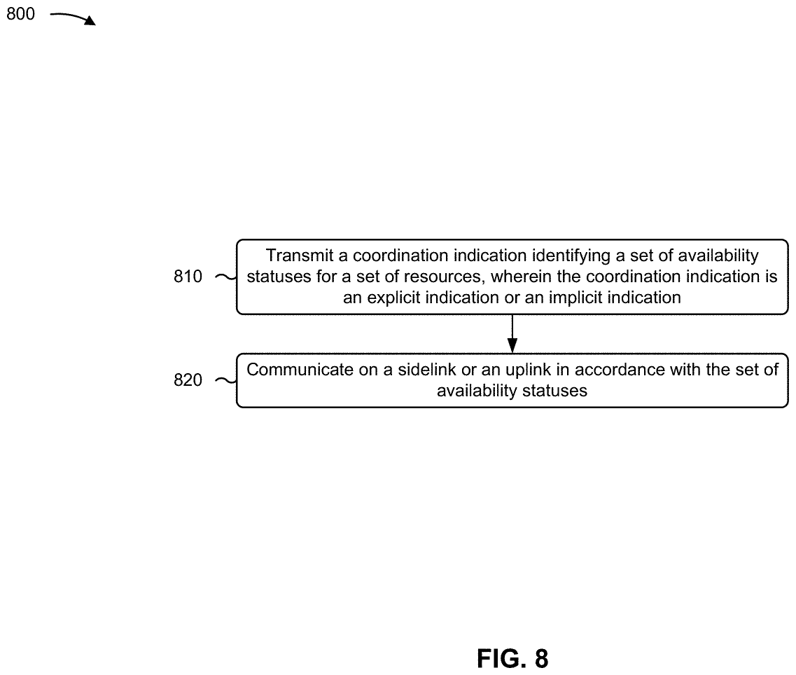

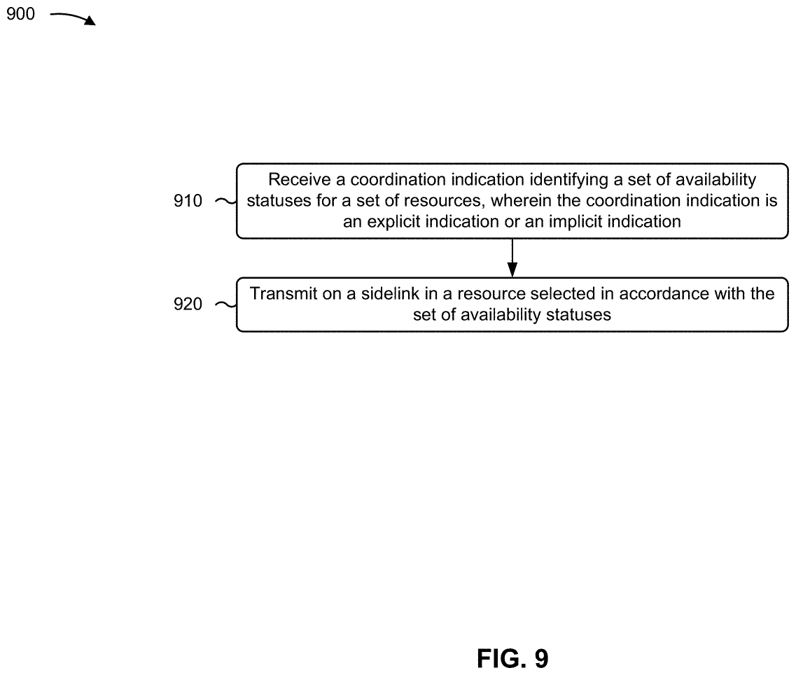

The controller/processor 240 of the base station 110, the controller/processor 280 of the UE 120, and/or any other component(s) of FIG. 2 may perform one or more techniques associated with indication of unavailable resources, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, a UE includes means for transmitting a coordination indication identifying a set of availability statuses for a set of resources, wherein the coordination indication is an explicit indication or an implicit indication; and/or means for communicating on a sidelink or an uplink in accordance with the set of availability statuses. The UE includes means for receiving a coordination indication identifying a set of availability statuses for a set of resources, wherein the coordination indication is an explicit indication or an implicit indication; and/or means for transmitting on a sidelink in a resource selected in accordance with the set of availability statuses. The means for the UE to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

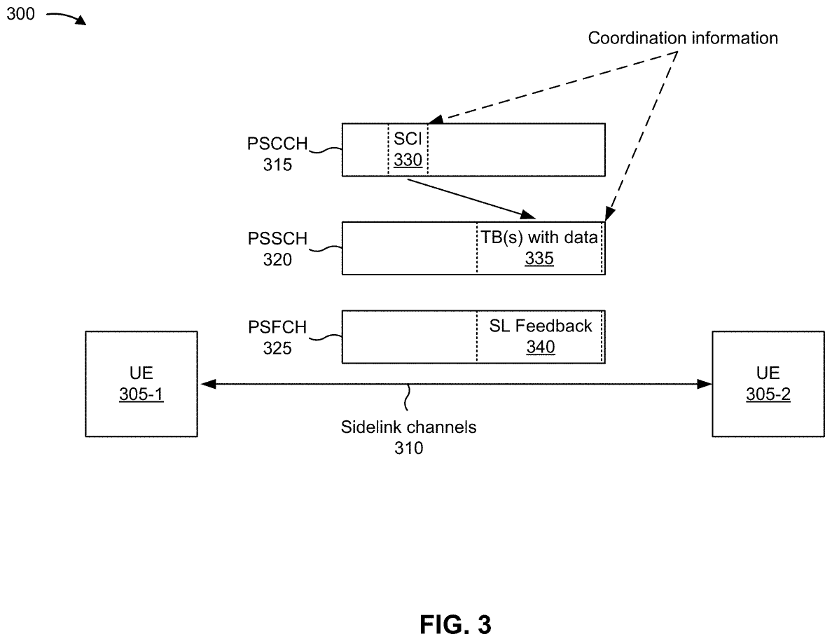

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications), wireless local area network (WLAN) communications, Bluetooth communications, and/or mesh networking. The UEs 305 (e.g., UE 305-1 and/or UE 305-2) may be one or more other UEs described elsewhere herein, such as UE 120. The one or more sidelink channels 310 may use a PC5 interface and/or may operate in a high frequency band (e.g., the 5.9 GHz band). In some other aspects, the one or more sidelink channels 310 may use another form of interface, such as a WiFi interface, a Bluetooth interface, or the like. It should be understood that the techniques described herein are not limited to NR sidelink communications (unless explicitly noted otherwise), and can be applied for other forms of communication without a central scheduler. The UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR). The PSSCH 320 may carry medium access control (MAC) signaling In some examples, the PSSCH 320 or the PSCCH 315 may carry radio resource control (RRC) signaling, such as RRC signaling originating from a PC5-RRC protocol entity.

Although shown on the PSCCH 315, in some examples, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, coordination information such as an indication of a non-preferred resource (described elsewhere herein), and/or an MCS. The SCI-2 may include information associated with data transmissions on the PSSCH 320, such as a HARQ process ID, a new data indicator (NDI), a source identifier, a destination identifier, coordination information such as an indication of a non-preferred resource (described elsewhere herein), and/or a channel state information (CSI) report trigger.

In some examples, the one or more sidelink channels 310 may use resource pools. A resource pool is a configured set of resources, associated with a sidelink connection, for communication on the sidelink connection. Resource pools can be configured with various parameters, described elsewhere herein. For example, a scheduling assignment (e.g., included in SCI 330) may be transmitted in sub-channels using specific resource blocks (RBs) across time. In some examples, data transmissions (e.g., on the PSSCH 320) associated with a scheduling assignment may occupy adjacent RBs in the same subframe as the scheduling assignment (e.g., using frequency division multiplexing). In some examples, a scheduling assignment and associated data transmissions are not transmitted on adjacent RBs.

In some examples, a UE 305 may operate using a transmission mode where resource selection and/or scheduling is performed by the UE 305 (e.g., rather than a base station 110). In some examples, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some examples, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

In some examples, as shown, a first UE 305-1 may transmit coordination information to a second UE 305-2, such as via the PSCCH 315, the PSSCH 320, PC5-RRC signaling, and/or MAC signaling The coordination information may aid in selecting resources (so as to reduce or avoid collision) for a sidelink transmission of the second UE 305-2.

As indicated above, FIG. 3 is provided as an example. Other examples may differ from what is described with respect to FIG. 3.

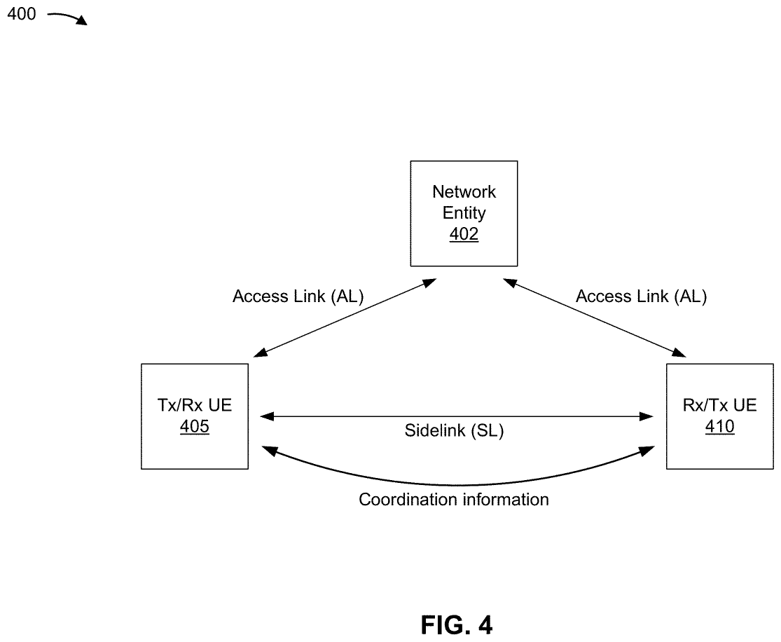

FIG. 4 is a diagram illustrating an example 400 of sidelink communications and access link communications, in accordance with the present disclosure. As mentioned in connection with FIG. 3, the techniques described herein are not limited to implementations involving NR sidelink communications.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network entity 402 may communicate with the Tx/Rx UE 405 via a first access link. Additionally, or alternatively, in some sidelink modes, the network entity 402 may communicate with the Rx/Tx UE 410 via a second access link. The Tx/Rx UE 405 and/or the Rx/Tx UE 410 may correspond to one or more UEs described elsewhere herein, such as the UE 120 of FIG. 1 or the UE 305 of FIG. 3. Thus, a direct link between UEs 120 (e.g., via a PC5 interface, a Bluetooth interface, a WiFi interface, or the like) may be referred to as a sidelink, and a direct link between a network entity 402 and a UE 120 (e.g., via a Uu interface) may be referred to as an access link. Sidelink communications may be transmitted via the sidelink, and access link communications may be transmitted via the access link. An access link communication may be either a downlink communication (from a network entity 402 to a UE 120) or an uplink communication (from a UE 120 to a network entity 402).

As indicated above, FIG. 4 is provided as an example. Other examples may differ from what is described with respect to FIG. 4.

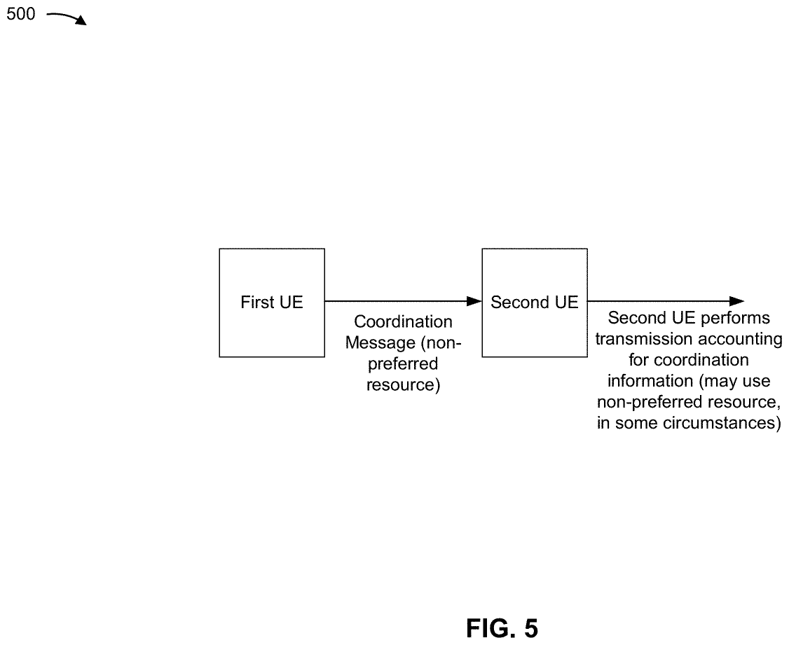

FIG. 5 is a diagram illustrating an example 500 of coordination signaling, in accordance with the present disclosure.

In example 500, a first UE (e.g., UE 120a of FIG. 1) exchanges inter-UE coordination signaling with a second UE (e.g., UE 120e of FIG. 1). The inter-UE coordination signaling may carry coordination information, sometimes referred to as inter-UE coordination information. “Inter-UE coordination signaling,” “coordination information,” and “inter-UE coordination information” are used interchangeably herein. The first UE and the second UE may operate in an in-coverage mode, a partial coverage mode, or an out-of-coverage mode with a network entity. In the in-coverage mode, the first UE and the second UE are covered by the network entity. In the partial coverage mode, one of the first UE and the second UE is covered by the network entity. In the out-of-coverage mode, neither of the first UE or the second UE are covered by the network entity.

The first UE may determine a set of sidelink resources available for a resource allocation. The first UE may determine the set of sidelink resources based at least in part on determining that the set of sidelink resources are to be selected or based at least in part on a request, referred to herein as an inter-UE coordination request, received from the second UE or a network entity. In some examples, the first UE may determine the set of sidelink resources based at least in part on a sensing operation, which may be performed before receiving an inter-UE coordination request or after receiving the inter-UE coordination request.

The first UE may transmit an indication of the set of available resources to the second UE via inter-UE coordination signaling (shown as a coordination message, and referred to in some examples as an inter-UE coordination message or inter-UE coordination information). In some examples, the first UE may transmit the indication of the set of available resources while operating in sidelink resource allocation mode 2. In sidelink resource allocation mode 2, resource allocation is handled by UEs (e.g., in comparison to sidelink resource allocation mode 1, in which resource allocation is handled by a scheduling entity, such as a network entity). In some examples, the indication of the set of available resources may identify resources that are preferred by the first UE for transmissions by the second UE. Additionally, or alternatively, the indication of the set of available resources may identify resources that are not preferred by the first UE for transmissions by the second UE, referred to herein as non-preferred sidelink resources (e.g., with the available resources being those other than the resources that are not preferred). Additionally, or alternatively, the inter-UE coordination signaling may indicate a resource conflict (e.g., a collision), such as when two UEs have reserved the same resource (e.g., and were unable to detect this conflict because the two UEs transmitted a resource reservation message on the same resource and thus did not receive one another's resource reservation messages due to a half-duplex constraint).

In some examples, a non-preferred sidelink resource, from the first UE's perspective, may be in a slot where the first UE is performing a transmission (whether an uplink transmission or a sidelink transmission) and cannot receive due to half-duplex constraints. Additionally, or alternatively, a non-preferred sidelink resource may be a resource that overlaps with resources where the first UE is expected to receive downlink or sidelink transmissions. Additionally, or alternatively, a non-preferred sidelink resource may be a resource that is in a period where the first UE is unable to receive due to a power saving configuration, such as a discontinuous reception (DRX) cycle.

The second UE may select a sidelink resource for a transmission from the second UE based at least in part on the set of available resources indicated by the first UE. As shown, the second UE may account for the coordination information when transmitting (e.g., via a sidelink resource indicated as available by the inter-UE coordination message). Inter-UE coordination signaling related to resource allocation may reduce collisions between the first UE and the second UE and may reduce a power consumption for the first UE and/or the second UE (e.g., due to fewer retransmissions as a result of fewer collisions). In some examples, described herein, the second UE may select a non-preferred resource for a communication.

Although FIG. 5 shows a single first UE transmitting inter-UE coordination information to a single second UE, in some examples, a single first UE may transmit inter-UE coordination information to multiple UEs to assist those UEs with selecting resources for transmissions. Additionally, or alternatively, the second UE may receive inter-UE coordination information from multiple UEs, and may use that information to select resources for a transmission (e.g., resources that avoid a conflict with all of the multiple UEs or as many as possible).

As indicated above, FIG. 5 is provided as an example. Other examples may differ from what is described with respect to FIG. 5.

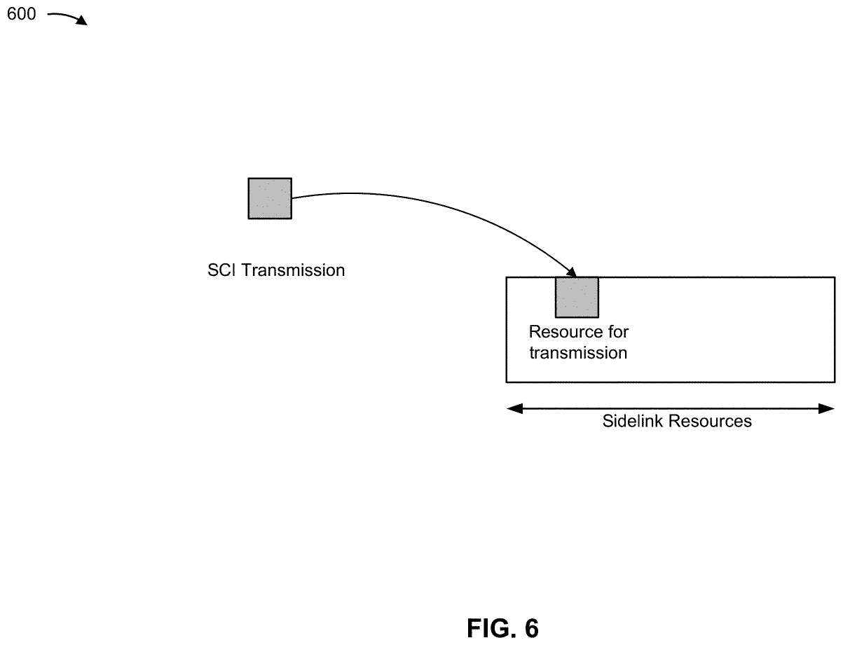

FIG. 6 is a diagram illustrating an example 600 of sidelink resource reservation, in accordance with the present disclosure.

As described above, in some cases, a first UE (e.g., UE 120a) cannot receive on a sidelink from a second UE (e.g., UE 120e), such as when the first UE is transmitting on an uplink or preparing to transmit on an uplink. In such a case, the first UE may transmit inter-UE coordination information to identify a set of resources over which the first UE cannot receive on a sidelink if a priority of a packet that is being transmitted is less than a threshold priority or if a remaining packet delay budget (PDB) of a packet transmitted by the second UE is greater than a threshold. The inter-UE coordination information may be applicable to a PSCCH, a PSSCH, or a PSFCH, among other examples. This may enable the second UE to refrain from transmission of low priority packets. However, when the second UE has a transmission with at least the threshold priority or with a remaining PDB that is less a threshold, the first UE is to prioritize receiving the transmission from the second UE over uplink transmission.

As shown in FIG. 6, the second UE may transmit SCI to the first UE. The second UE may transmit the SCI before an unavailability period (e.g., that the first UE has identified in an inter-UE coordination indication) to reserve a sidelink resource in a resource reservation window and to indicate that the second UE is to transmit a communication with a relatively high priority in the reserved resource. In this case, the first UE is signaled to prioritize receiving on a sidelink over transmitting on an uplink in a particular resource even though the first UE has indicated that the particular resource is unavailable for sidelink transmission.

However, inter-UE coordination indications, that are used by the second UE to determine whether to transmit SCI to reserve a resource, may lack information to enable the second UE to identify whether a resource is not available for sidelink reception rather than merely being non-preferred. Some aspects described herein provide techniques for indication of unavailable resources. For example, a first UE may transmit an inter-UE coordination indication that identifies resources that are not available for sidelink reception, and a second UE may use the inter-UE coordination indication to determine whether to transmit SCI to override the unavailability of the resources and enable transmission of a high priority communication.

As indicated above, FIG. 6 is provided as an example. Other examples may differ from what is described with respect to FIG. 6.

FIG. 7 is a diagram illustrating an example 700 associated with indication of unavailable resources, in accordance with the present disclosure. As shown in FIG. 7, example 700 includes communication between a first UE 705 and a second UE 710. In some aspects, first UE 705 and second UE 710 may correspond to one or more UEs 120 and/or one or more other UEs described herein. In some aspects, UEs 705 and 710 may be included in a wireless network, such as wireless network 100. UEs 705 and 710 may communicate via a wireless sidelink, which may include a forward link and a reverse link.

As further shown in FIG. 7, and by reference number 715, first UE 705 may transmit a coordination indication. For example, first UE 705 may transmit a coordination indication with a set of availability statuses (e.g., whether a resource is available or unavailable for first UE 705 to receive on a sidelink) for a set of resources (e.g., a set of slots). In some aspects, the coordination indication may include an explicit indication of the set of availability statuses. For example, first UE 705 may transmit an explicit indication that first UE 705 is not available for sidelink reception on a set of resources based at least in part on first UE 705 being scheduled for uplink transmission or to prepare for uplink transmission during the set of resources. Additionally, or alternatively, first UE 705 may transmit an implicit indication that tags a set of resources as non-preferred based at least in part on first UE 705 being scheduled or configured for uplink transmission or to prepare for uplink transmission during the set of resources. In this case, the coordination indication may also include information identifying another set of resources as non-preferred based at least in part on, for example, a sensing procedure performed by first UE 705 or other coordination information obtained by first UE 705.

In some aspects, the coordination indication identifies a set of resources as being available for uplink communication. For example, first UE 705 may identify a set of resources that is scheduled for uplink communication (and where first UE 705 cannot receive sidelink communication) and may transmit the coordination indication to indicate that the set of resources is scheduled for uplink communication. In this case, second UE 710 may determine that the set of resources is unavailable for first UE 705 to receive on a sidelink based at least in part on the set of resources being available for transmission on an uplink. Additionally, or alternatively, the coordination indication identifies the set of resources as being unavailable for sidelink communication. For example, first UE 705 may transmit the coordination indication to indicate one or more slots that are specified as unavailable for sidelink reception by first UE 705.

In some aspects, first UE 705 may transmit the coordination indication aperiodically. For example, when first UE 705 is receiving dynamic uplink grants of resources for uplink transmission, first UE 705 may transmit aperiodic coordination indication messages to indicate resources not available for sidelink reception. Additionally, or alternatively, first UE 705 may transmit the coordination indication periodically. For example, when first UE 705 is configured with periodic uplink resources (e.g., via a configured grant (CG)-PUSCH), but does not always use the periodic uplink resources (e.g., when first UE 705 does not have traffic for uplink transmission), first UE 705 may transmit periodic coordination indication to indicate whether first UE 705 is using the periodic uplink resources (and is unavailable for sidelink reception). In some aspects, first UE 705 may use activation or deactivation signaling to convey the coordination indication. For example, when first UE 705 is configured with periodic and deterministic uplink traffic, first UE 705 may transmit signaling (e.g., an activation message) to indicate that first UE 705 is unavailable for sidelink reception on a set of resources until first UE 705 transmits further signaling indicating otherwise (e.g., a de-activation message).

In some aspects, first UE 705 may transmit the coordination indication in a joint message that also includes an indication of preferred or non-preferred resources. For example, first UE 705 may transmit a single inter-UE coordination message that identifies a first set of resources as unavailable for sidelink reception (e.g., when first UE 705 is transmitting on an uplink) and a second set of resources as non-preferred for reservation (e.g., when first UE 705 determines that, for example, interference may occur as a result of a sensing procedure). Additionally, or alternatively, the joint message may be, in some cases, not included in an inter-UE coordination message. For example, first UE 705 may include an indicator of whether an inter-UE coordination message includes indications of both unavailable and non-preferred resources, to enable second UE 710 to accurately interpret the inter-UE coordination message. In some aspects, first UE 705 may transmit the coordination indication separately from an indication of non-preferred resources. In some aspects, first UE 705 may transmit the coordination indication via SCI (e.g., SCI type 1 (SCI1) or SCI type 2 (SCI2)) or a MAC control element (CE), among other examples.

In some aspects, the coordination indication may have a particular format for indicating unavailable resources. For example, first UE 705 may configure a bitmap of slot indices where a value of each bit in the bitmap indicates whether a corresponding slot is available or unavailable. Additionally, or alternatively, first UE 705 may configure a bitmap where each set of bits indicates one of a plurality of statuses (e.g., a two bit bitmap could indicate a slot as available, unavailable, preferred, or non-preferred). In some aspects, first UE 705 may include a slot identifier and duration identifier in the coordination indication. For example, first UE 705 may identify a starting slot (e.g., at which first UE 705 is unavailable for sidelink reception) and a duration (e.g., of slots during which first UE 705 remains unavailable for sidelink reception) in the coordination indication. In some aspects, the duration may be defined with respect to only slots that are available for a resource pool for sidelink communication or with respect to all slots (e.g., both slots that are available for the resource pool and unavailable for the resource pool). In some aspects, first UE 705 may include a periodicity indicator (e.g., to indicate a periodicity of slots in which first UE 705 is unavailable for sidelink reception).

In some aspects, the coordination indication may include an indicator of a reference point for interpreting the coordination indication. For example, first UE 705 may indicate a reference point from which to derive a slot that corresponds to the first bit of the bitmap. Additionally, or alternatively, first UE 705 may define a time reference with respect to a slot where the coordination indication is signaled. For example, first UE 705 may transmit the coordination indication in a particular slot and may define one or more parameters of the coordination indication (e.g., a slot to which the first bit of a bitmap corresponds) relative to the particular slot.

In some aspects, the coordination indication may be resource pool specific or sidelink component carrier specific. For example, first UE 705 may transmit the coordination indication in a particular component carrier to apply to sidelink reservations on the particular component carrier. Additionally, or alternatively, first UE 705 may transmit a coordination indication that is cross-resource pool or cross-component carrier (e.g., first UE 705 may transmit the coordination indication in a first component carrier to apply to resource reservations in a second component carrier).

As further shown in FIG. 7, and by reference number 720, second UE 710 may use an unavailable resource for communication, based at least in part on a condition being satisfied. For example, second UE 710 may determine that a sidelink communication has a threshold priority and may determine to use a resource, indicated as an unavailable resource in the coordination indication, for transmission of the sidelink communication. In some aspects, second UE 710 may interpret the coordination indication based at least in part on a timing with which second UE 710 received the coordination indication. For example, when second UE 710 receives the coordination indication during a sensing window, second UE 710 may determine that resources indicated by the coordination indication are unavailable and may forgo selection of the resources indicated by the coordination indication. In contrast, when second UE 710 receives the coordination indication at a time t>slot n−T_{proc,0} (where T_{proc,0} represents a processing time), second UE 710 may use the coordination indication to reevaluate whether to use a selected resource that is indicated as unavailable in the coordination indication. In this case, if a priority is greater than a threshold, second UE 710 may continue using the selected resource, and if the priority is less than the threshold, second UE 710 may forgo using the selected resource.

As further shown in FIG. 7, and by reference number 725, second UE 710 may transmit an indication that second UE 710 is to use an unavailable resource for a high priority communication. For example, second UE 710 may transmit SCI to indicate that second UE 710 is to transmit or re-transmit a communication on a sidelink to first UE 705 with a priority satisfying a threshold (e.g., which may be configured based at least in part on signaling communicated between first UE 705 and second UE 710). In this case, second UE 710 may transmit the SCI a threshold time period before the unavailable resources or the reserved resource to facilitate processing of the SCI by first UE 705. Additionally, or alternatively, second UE 710 may transmit an indication that second UE 710 is to use an unavailable resource for a transmission of a packet with a remaining PDB that is less than a threshold (e.g., a threshold that may be configured based at least in part on signaling communicated between first UE 705 and second UE 710). In some aspects, a transmission of a packet with a remaining PDB that is less than a threshold may be classified or treated as a high priority communication.

As further shown in FIG. 7, and by reference number 730, first UE 705 and second UE 710 may communicate using an unavailable resource. For example, second UE 710 may transmit a communication on a sidelink to first UE 705 in accordance with the coordination indication. In this case, first UE 705 may forgo transmitting on an uplink in the resource that second UE 710 is transmitting on a sidelink. In another example, when a communication of second UE 710 does not satisfy a threshold priority and second UE 710 determines not to transmit in the unavailable resource, first UE 705 may transmit on the uplink in the unavailable resource.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with indication of unavailable resources.

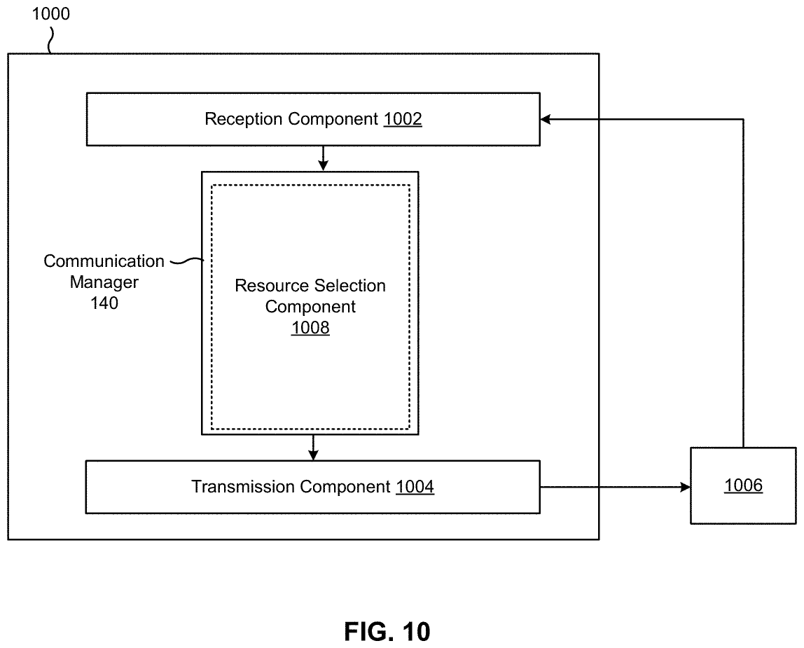

As shown in FIG. 8, in some aspects, process 800 may include transmitting a coordination indication identifying a set of availability statuses for a set of resources, wherein the coordination indication is an explicit indication or an implicit indication (block 810). For example, the UE (e.g., using communication manager 140 and/or transmission component 1004, depicted in FIG. 10) may transmit a coordination indication identifying a set of availability statuses for a set of resources, wherein the coordination indication is an explicit indication or an implicit indication, as described above.

As further shown in FIG. 8, in some aspects, process 800 may include communicating on a sidelink or an uplink in accordance with the set of availability statuses (block 820). For example, the UE (e.g., using communication manager 140 and/or reception component 1002 or transmission component 1004, depicted in FIG. 10) may communicate on a sidelink or an uplink in accordance with the set of availability statuses, as described above.

Process 800 may include additional aspects, such as any single aspect or any combination of aspects described below and/or in connection with one or more other processes described elsewhere herein.

In a first aspect, transmitting the coordination indication comprises transmitting the implicit indication to identify one or more resources, of the set of resources, as non-preferred resources.

In a second aspect, alone or in combination with the first aspect, transmitting the coordination indication comprises transmitting the explicit indication to identify one or more resources, of the set of resources, as not available for sidelink reception.

In a third aspect, alone or in combination with one or more of the first and second aspects, an availability status, of the set of availability statuses, indicates whether a resource, of the set of resources, is available for uplink transmission or is unavailable for sidelink reception.

In a fourth aspect, alone or in combination with one or more of the first through third aspects, the coordination indication is included in at least one of an aperiodic message, a periodic message, an activation message, a deactivation message, or a combination thereof.

In a fifth aspect, alone or in combination with one or more of the first through fourth aspects, the coordination indication is included in a message that includes an indicator of one or more other availability statuses of one or more other resources.

In a sixth aspect, alone or in combination with one or more of the first through fifth aspects, the coordination indication is included in a standalone message that does not include an indicator of one or more other availability statuses of one or more other resources.

In a seventh aspect, alone or in combination with one or more of the first through sixth aspects, the coordination indication comprises a bitmap of slot indices or comprises an identifier of a starting slot and a time duration.

In an eighth aspect, alone or in combination with one or more of the first through seventh aspects, the time duration is defined with respect to only available slots of a resource pool or both available slots and unavailable slots of the resource pool.

In a ninth aspect, alone or in combination with one or more of the first through eighth aspects, a time reference for the coordination indication is defined with respect to a slot in which the coordination indication is signaled.

In a tenth aspect, alone or in combination with one or more of the first through ninth aspects, the coordination indication is resource pool specific or sidelink component carrier specific.

In an eleventh aspect, alone or in combination with one or more of the first through tenth aspects, the coordination indication is a cross-resource pool indication or a cross-component carrier indication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with indication of unavailable resources.

As shown in FIG. 9, in some aspects, process 900 may include receiving a coordination indication identifying a set of availability statuses for a set of resources, wherein the coordination indication is an explicit indication or an implicit indication (block 910). For example, the UE (e.g., using communication manager 140 and/or reception component 1002, depicted in FIG. 10) may receive a coordination indication identifying a set of availability statuses for a set of resources, wherein the coordination indication is an explicit indication or an implicit indication, as described above.

As further shown in FIG. 9, in some aspects, process 900 may include transmitting on a sidelink in a resource selected in accordance with the set of availability statuses (block 920). For example, the UE (e.g., using communication manager 140 and/or transmission component 1004, depicted in FIG. 10) may transmit on a sidelink in a resource selected in accordance with the set of availability statuses, as described above.

Process 900 may include additional aspects, such as any single aspect or any combination of aspects described below and/or in connection with one or more other processes described elsewhere herein.

In a first aspect, receiving the coordination indication comprises receiving the implicit indication to identify one or more resources, of the set of resources, as non-preferred resources.

In a second aspect, alone or in combination with the first aspect, receiving the coordination indication comprises receiving the explicit indication to identify one or more resources, of the set of resources, as not available for sidelink reception.

In a third aspect, alone or in combination with one or more of the first and second aspects, an availability status, of the set of availability statuses, indicates whether a resource, of the set of resources, is available for uplink transmission or is unavailable for sidelink reception.

In a fourth aspect, alone or in combination with one or more of the first through third aspects, the coordination indication is included in at least one of an aperiodic message, a periodic message, an activation message, a deactivation message, or a combination thereof.

In a fifth aspect, alone or in combination with one or more of the first through fourth aspects, the coordination indication is included in a message that includes an indicator of one or more other availability statuses of one or more other resources.

In a sixth aspect, alone or in combination with one or more of the first through fifth aspects, the coordination indication is included in a standalone message that does not include an indicator of one or more other availability statuses of one or more other resources.

In a seventh aspect, alone or in combination with one or more of the first through sixth aspects, the coordination indication comprises a bitmap of slot indices or comprises an identifier of a starting slot and a time duration.

In an eighth aspect, alone or in combination with one or more of the first through seventh aspects, the time duration is defined with respect to only available slots of a resource pool or both available slots and unavailable slots of the resource pool.

In a ninth aspect, alone or in combination with one or more of the first through eighth aspects, a time reference for the coordination indication is defined with respect to a slot in which the coordination indication is signaled.

In a tenth aspect, alone or in combination with one or more of the first through ninth aspects, the coordination indication is resource pool specific or sidelink component carrier specific.

In an eleventh aspect, alone or in combination with one or more of the first through tenth aspects, the coordination indication is a cross-resource pool indication or a cross-component carrier indication.

In a twelfth aspect, alone or in combination with one or more of the first through eleventh aspects, process 900 includes selecting resources for transmission based at least in part on a timing of receiving the coordination indication.

In a thirteenth aspect, alone or in combination with one or more of the first through twelfth aspects, process 900 includes transmitting sidelink control information to indicate a transmission of a packet with a priority in a resource, wherein the sidelink control information is transmitted a quantity of slots before the resource.

In a fourteenth aspect, alone or in combination with one or more of the first through thirteenth aspects, process 900 includes transmitting signaling reserving a resource for a new transmission or a retransmission of a packet during a slot of an unavailability period associated with the set of availability statuses.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a block diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a resource selection component 1008, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the UE described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the UE described above in connection with FIG. 2. In some aspects, the transmission component 1004 may be co-located with the reception component 1002 in a transceiver.

The transmission component 1004 may transmit a coordination indication identifying a set of availability statuses for a set of resources, wherein the coordination indication is an explicit indication or an implicit indication. The reception component 1002 or the transmission component 1004 may communicate on a sidelink or an uplink, respectively, in accordance with the set of availability statuses.

The reception component 1002 may receive a coordination indication identifying a set of availability statuses for a set of resources, wherein the coordination indication is an explicit indication or an implicit indication. The transmission component 1004 may transmit on a sidelink in a resource selected in accordance with the set of availability statuses. The resource selection component 1008 may select resources for transmission based at least in part on a timing of receiving the coordination indication. The transmission component 1004 may transmit sidelink control information to indicate a transmission of a packet with a priority in a resource, wherein the sidelink control information is transmitted a quantity of slots before the resource.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting a coordination indication identifying a set of availability statuses for a set of resources, wherein the coordination indication is an explicit indication or an implicit indication; and communicating on a sidelink or an uplink in accordance with the set of availability statuses.

Aspect 2: The method of Aspect 1, wherein transmitting the coordination indication comprises: transmitting the implicit indication to identify one or more resources, of the set of resources, as non-preferred resources.

Aspect 3: The method of any of Aspects 1 to 2, wherein transmitting the coordination indication comprises: transmitting the explicit indication to identify one or more resources, of the set of resources, as not available for sidelink reception.

Aspect 4: The method of any of Aspects 1 to 3, wherein an availability status, of the set of availability statuses, indicates whether a resource, of the set of resources, is available for uplink transmission or is unavailable for sidelink reception.

Aspect 5: The method of any of Aspects 1 to 4, wherein the coordination indication is included in at least one of: an aperiodic message, a periodic message, an activation message, a deactivation message, or a combination thereof.

Aspect 6: The method of any of Aspects 1 to 5, wherein the coordination indication is included in a message that includes an indicator of one or more other availability statuses of one or more other resources.

Aspect 7: The method of any of Aspects 1 to 6, wherein the coordination indication is included in a standalone message that does not include an indicator of one or more other availability statuses of one or more other resources.

Aspect 8: The method of any of Aspects 1 to 7, wherein the coordination indication comprises a bitmap of slot indices or comprises an identifier of a starting slot and a time duration.

Aspect 9: The method of Aspect 8, wherein the time duration is defined with respect to only available slots of a resource pool or both available slots and unavailable slots of the resource pool.

Aspect 10: The method of any of Aspects 1 to 9, wherein a time reference for the coordination indication is defined with respect to a slot in which the coordination indication is signaled.

Aspect 11: The method of any of Aspects 1 to 10, wherein the coordination indication is resource pool specific or sidelink component carrier specific.

Aspect 12: The method of Aspect 11, wherein the coordination indication is a cross-resource pool indication or a cross-component carrier indication.

Aspect 13: A method of wireless communication performed by a user equipment (UE), comprising: receiving a coordination indication identifying a set of availability statuses for a set of resources, wherein the coordination indication is an explicit indication or an implicit indication; and transmitting on a sidelink in a resource selected in accordance with the set of availability statuses.

Aspect 14: The method of Aspect 13, wherein receiving the coordination indication comprises: receiving the implicit indication to identify one or more resources, of the set of resources, as non-preferred resources.

Aspect 15: The method of any of Aspects 13 to 14, wherein receiving the coordination indication comprises: receiving the explicit indication to identify one or more resources, of the set of resources, as not available for sidelink reception.

Aspect 16: The method of any of Aspects 13 to 15, wherein an availability status, of the set of availability statuses, indicates whether a resource, of the set of resources, is available for uplink transmission or is unavailable for sidelink reception.

Aspect 17: The method of any of Aspects 13 to 16, wherein the coordination indication is included in at least one of: an aperiodic message, a periodic message, an activation message, a deactivation message, or a combination thereof.

Aspect 18: The method of any of Aspects 13 to 17, wherein the coordination indication is included in a message that includes an indicator of one or more other availability statuses of one or more other resources.

Aspect 19: The method of any of Aspects 13 to 18, wherein the coordination indication is included in a standalone message that does not include an indicator of one or more other availability statuses of one or more other resources.

Aspect 20: The method of any of Aspects 13 to 19, wherein the coordination indication comprises a bitmap of slot indices or comprises an identifier of a starting slot and a time duration.

Aspect 21: The method of Aspect 20, wherein the time duration is defined with respect to only available slots of a resource pool or both available slots and unavailable slots of the resource pool.

Aspect 22: The method of any of Aspects 13 to 21, wherein a time reference for the coordination indication is defined with respect to a slot in which the coordination indication is signaled.

Aspect 23: The method of any of Aspects 13 to 22, wherein the coordination indication is resource pool specific or sidelink component carrier specific.

Aspect 24: The method of Aspect 23, wherein the coordination indication is a cross-resource pool indication or a cross-component carrier indication.

Aspect 25: The method of any of Aspects 13 to 24, further comprising: selecting resources for transmission based at least in part on a timing of receiving the coordination indication.

Aspect 26: The method of any of Aspects 13 to 25, further comprising: transmitting sidelink control information to indicate a transmission of a packet with a priority in a resource, wherein the sidelink control information is transmitted a quantity of slots before the resource.

Aspect 27: The method of any of Aspects 13 to 26, further comprising: transmitting signaling reserving a resource for a new transmission or a retransmission of a packet during a slot of an unavailability period associated with the set of availability statuses.

Aspect 28: An apparatus for wireless communication at a device, comprising a processor; memory coupled with the processor; and instructions stored in the memory and executable by the processor to cause the apparatus to perform the method of one or more of Aspects 1-12.

Aspect 29: A device for wireless communication, comprising a memory and one or more processors coupled to the memory, the memory and the one or more processors configured to perform the method of one or more of Aspects 1-12.

Aspect 30: An apparatus for wireless communication, comprising at least one means for performing the method of one or more of Aspects 1-12.

Aspect 31: A non-transitory computer-readable medium storing code for wireless communication, the code comprising instructions executable by a processor to perform the method of one or more of Aspects 1-12.

Aspect 32: A non-transitory computer-readable medium storing a set of instructions for wireless communication, the set of instructions comprising one or more instructions that, when executed by one or more processors of a device, cause the device to perform the method of one or more of Aspects 1-12.

Aspect 33: An apparatus for wireless communication at a device, comprising a processor; memory coupled with the processor; and instructions stored in the memory and executable by the processor to cause the apparatus to perform the method of one or more of Aspects 13-27.

Aspect 34: A device for wireless communication, comprising a memory and one or more processors coupled to the memory, the memory and the one or more processors configured to perform the method of one or more of Aspects 13-27.

Aspect 35: An apparatus for wireless communication, comprising at least one means for performing the method of one or more of Aspects 13-27.

Aspect 36: A non-transitory computer-readable medium storing code for wireless communication, the code comprising instructions executable by a processor to perform the method of one or more of Aspects 13-27.

Aspect 37: A non-transitory computer-readable medium storing a set of instructions for wireless communication, the set of instructions comprising one or more instructions that, when executed by one or more processors of a device, cause the device to perform the method of one or more of Aspects 13-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit a coordination indication identifying a set of availability statuses for a set of resources, wherein the coordination indication is an explicit indication or an implicit indication; and
communicate on a sidelink or an uplink in accordance with the set of availability statuses.

2. The UE of claim 1, wherein the one or more processors, to transmit the coordination indication, are configured to:
transmit the implicit indication to identify one or more resources, of the set of resources, as non-preferred resources.

3. The UE of claim 1, wherein the one or more processors, to transmit the coordination indication, are configured to:
transmit the explicit indication to identify one or more resources, of the set of resources, as not available for sidelink reception.

4. The UE of claim 1, wherein an availability status, of the set of availability statuses, indicates whether a resource, of the set of resources, is available for uplink transmission or is unavailable for sidelink reception.

5. The UE of claim 1, wherein the coordination indication is included in at least one of:
an aperiodic message,
a periodic message,
an activation message,
a deactivation message, or
a combination thereof.

6. The UE of claim 1, wherein the coordination indication is included in a message that includes an indicator of one or more other availability statuses of one or more other resources.

7. The UE of claim 1, wherein the coordination indication is included in a standalone message that does not include an indicator of one or more other availability statuses of one or more other resources.

8. The UE of claim 1, wherein the coordination indication comprises a bitmap of slot indices or comprises an identifier of at least one of a starting slot, a time duration, or a periodicity.

9. The UE of claim 8, wherein the time duration is defined with respect to only available slots of a resource pool or both available slots and unavailable slots of the resource pool.

10. The UE of claim 1, wherein a time reference for the coordination indication is defined with respect to a slot in which the coordination indication is signaled.

11. The UE of claim 1, wherein the coordination indication is resource pool specific or sidelink component carrier specific.

12. The UE of claim 11, wherein the coordination indication is a cross-resource pool indication or a cross-component carrier indication.

13. A user equipment (UE) for wireless communication, comprising:
a memory; and
one or more processors, coupled to the memory, configured to:
receive a coordination indication identifying a set of availability statuses for a set of resources, wherein the coordination indication is an explicit indication or an implicit indication; and
transmit on a sidelink in a resource selected in accordance with the set of availability statuses.

14. The UE of claim 13, wherein the one or more processors, to receive the coordination indication, are configured to:
receive the implicit indication to identify one or more resources, of the set of resources, as non-preferred resources.

15. The UE of claim 13, wherein the one or more processors, to receive the coordination indication, are configured to:
receive the explicit indication to identify one or more resources, of the set of resources, as not available for sidelink reception.

16. The UE of claim 13, wherein an availability status, of the set of availability statuses, indicates whether a resource, of the set of resources, is available for uplink transmission or is unavailable for sidelink reception.

17. The UE of claim 13, wherein the coordination indication is included in at least one of:
an aperiodic message,
a periodic message,
an activation message,
a deactivation message, or
a combination thereof.

18. The UE of claim 13, wherein the coordination indication is included in a message that includes an indicator of one or more other availability statuses of one or more other resources.

19. The UE of claim 13, wherein the coordination indication is included in a standalone message that does not include an indicator of one or more other availability statuses of one or more other resources.

20. The UE of claim 13, wherein the coordination indication comprises a bitmap of slot indices or comprises an identifier of at least one of a starting slot, a time duration, or a periodicity.

21. The UE of claim 20, wherein the time duration is defined with respect to only available slots of a resource pool or both available slots and unavailable slots of the resource pool.

22. The UE of claim 13, wherein a time reference for the coordination indication is defined with respect to a slot in which the coordination indication is signaled.

23. The UE of claim 13, wherein the coordination indication is resource pool specific or sidelink component carrier specific.

24. The UE of claim 23, wherein the coordination indication is a cross-resource pool indication or a cross-component carrier indication.

25. The UE of claim 13, wherein the one or more processors are further configured to:
select resources for transmission based at least in part on a timing of receiving the coordination indication.

26. The UE of claim 13, wherein the one or more processors are further configured to:
transmit sidelink control information to indicate a transmission of a packet with a priority or a packet delay budget in a resource, wherein the sidelink control information is transmitted a quantity of slots before the resource.

27. The UE of claim 13, wherein the one or more processors are further configured to:
transmit signaling reserving a resource for a new transmission or a retransmission of a packet during a slot of an unavailability period associated with the set of availability statuses.

28. A method of wireless communication performed by a user equipment (UE), comprising:
transmitting a coordination indication identifying a set of availability statuses for a set of resources, wherein the coordination indication is an explicit indication or an implicit indication; and
communicating on a sidelink or an uplink in accordance with the set of availability statuses.

29. The method of claim 28, wherein transmitting the coordination indication comprises:
transmitting the implicit indication to identify one or more resources, of the set of resources, as non-preferred resources.

30. A method of wireless communication performed by a user equipment (UE), comprising:
receiving a coordination indication identifying a set of availability statuses for a set of resources, wherein the coordination indication is an explicit indication or an implicit indication; and
transmitting on a sidelink in a resource selected in accordance with the set of availability statuses.
